(19) United States
(12) Patent Application Publication
(10) Pub. No.: US 2002/0131270 A1
(43) Pub. Date: Sep. 19, 2002

(54) Illuminated computer mouse pad

(76) Inventor: Alan J. Niemuth, Chino Hills, CA (US)

Correspondence Address: ALAN J NIEMUTH, 3274 STRATFORD AVENUE, CHINO HILLS, CA, 91709, US

(21) Appl. No.: 09/804,793

(22) Filed: Mar. 14, 2001

(51) Int. Cl. F21V 33/00

(52) U.S. Cl. 362/253

(57) ABSTRACT

A geometric shaped flat translucent computer mouse pad which becomes illuminated when contacted with an external light source. Said light source will most likely originate from, but is not limited to, a computer based optical input device.

### TITLE OF INVENTION

Illuminated computer mouse pad.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The use of a hand operated mechanical pointing device for use with a computer and its display has become the norm. By far the most popular of the various devices is the conventional mouse. More recently, computers are becoming available with input devices which incorporate a computer mouse utilizing optics for input.

These optics require no mechanical moving parts and therefore are not susceptible to wear or breakage. Additionally due to the manner in which these optics capture data to determine user motion, the use of a special surface to provide accurate cursor tacking is unnecessary and is therefore, used more for ornamental purposes.

The pleasant effects of the optical mechanisms in these devices is the red illumination of the mouse and it's surrounding areas when used. Therefore to enhance and multiply this effect, a computer mouse pad which captures and dispenses this light in beautiful and unusual patterns is needed. Accordingly, many effects can be achieved by capturing, refracting, and re-emitting this optical light source.

### FIELD OF THE INVENTION

This invention relates generally to peripherals used in conjunction with optical devices for controlling a cursor on a computer display screen, also known as optical computer pointing devices.

### SUMMARY OF THE INVENTION

The preferred embodiment of the invention is shaped like a normal mouse pad. The surface of the pad will be translucent; composed of a substance such as plastic; specifically acrylic in nature such as: Plexiglass, Lexan, Lucite, Optix, or the like.

Enclosed within the external embodiment will be fiber optic cable, plastic, glass, liquid, gas or similar substance capable of capture, refraction, and re-emission of various light sources.

These combined components will provide the vehicle for illumination of said invention.

### BRIEF DESCRIPTION OF THE DRAWINGS

FIG. 1 is an illustration of one of the many geometric shapes of the illuminated computer mouse pad.

FIG. 2 is an illustration of the major components of the illuminated computer mouse pad in cross section.

### DETAILED DESCRIPTION OF THE PREFERRED EMBODIMENTS

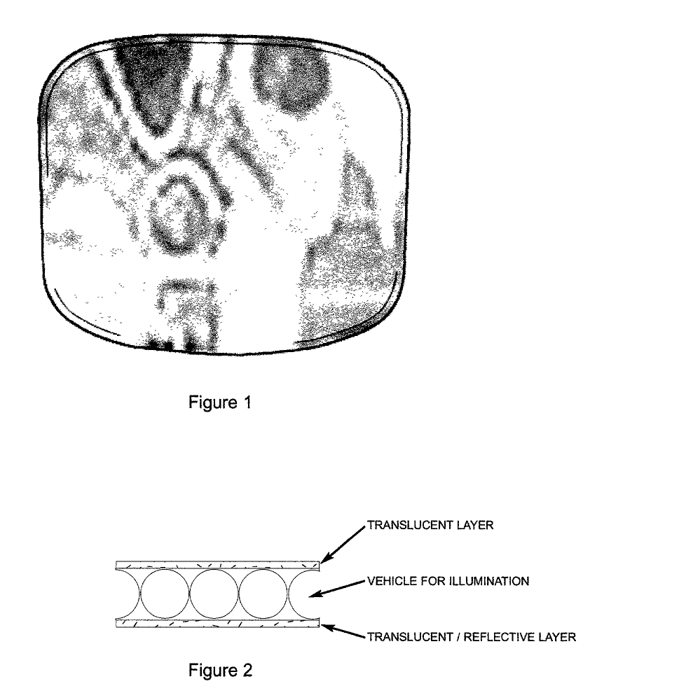

FIG. 1 illustrates the preferred embodiment of the illuminated computer mouse pad.

Although several embodiments of the invention have been described and illustrated, the invention is not to be limited to the specific forms or arrangements of parts so described and illustrated. The invention is limited only by the claims.

What is claimed is:

1. An illuminated computer mouse pad or the like, said mouse pad comprising:
a body, said body being generally geometric in shape and flat;
a vehicle to provide illumination, said vehicle being disposed inside said body and refracting light sources which are brought in contact with said body and thereby causing illumination, substances which will be used to provide illumination will include, but are not limited to varieties of; fiber optics, plastics, glass, liquids, and gas.
